(19) United States
(12) Patent Application Publication
(10) Pub. No.: US 2022/0141398 A1
(43) Pub. Date: May 5, 2022

(54) INFORMATION PROCESSING DEVICE, RADIATION DETECTOR, INFORMATION PROCESSING METHOD, AND INFORMATION PROCESSING PROGRAM

(71) Applicant: FUJIFILM CORPORATION, Tokyo (JP)

(72) Inventors: Koichi KITANO, Kanagawa (JP); Sho SHIMIZUKAWA, Kanagawa (JP); Kentaro NOMA, Kanagawa (JP)

(21) Appl. No.: 17/505,641

(22) Filed: Oct. 20, 2021

(30) Foreign Application Priority Data
Oct. 30, 2020 (JP) 2020-183112

(51) Int. Cl. H04N 5/32; H04W 76/15; H04N 7/18; G06F 3/14; G06F 3/02

(52) U.S. Cl. CPC H04N 5/32; H04W 76/15; G06F 3/02; G06F 3/1423; H04N 7/183

(57) ABSTRACT

A radiation detector can perform wireless communication and includes a CPU that is provided in a housing accommodating a radiation detection unit. The CPU receives an instruction to change a connection destination of the wireless communication which is input by operating an operation button that is provided in the housing to input the instruction to change the connection destination and specifies a connection destination corresponding to the change instruction from a plurality of preset connection destinations in a case in which the change instruction is received. The CPU determines whether or not a connection to the plurality of connection destinations by the wireless communication is possible. The CPU performs control to display information indicating that the connection is not possible on a display unit provided in the housing in a case in which it is determined that the connection to the specified connection destination by the wireless communication is not possible.

### CROSS-REFERENCE TO RELATED APPLICATIONS

The present application claims priority under 35 U.S.C. § 119 to Japanese Patent Application No. 2020-183112, filed on Oct. 30, 2020. The above application is hereby expressly incorporated by reference, in its entirety, into the present application.

### BACKGROUND

### 1. Technical Field

The present disclosure relates to an information processing device, a radiation detector, an information processing method, and an information processing program.

### 2. Description of the Related Art

In general, a radiation detector that generates a radiographic image corresponding to radiation transmitted through a subject is known. Radiographic images are captured under the control of a control device such as a so-called console. In some cases, the control device and the radiation detector are connected to each other by wireless communication.

For example, a technique disclosed in JP2012-100843A is known as a technique for connection to a connection destination by wireless communication. In the technique disclosed in JP2012-100843A, access points are associated with each of a plurality of imaging devices, and a radiation detector captures an image using an imaging device associated with an access point having a signal intensity equal to or greater than a predetermined threshold value in a case in which each access point receives signals from the radiation detector using wireless communication.

### SUMMARY

However, in some cases, the connection destination of the radiation detector by wireless communication is inappropriate. For example, in the technique disclosed in JP2012-100843A, the access point having a signal intensity equal to or greater than the threshold value, that is, the imaging device and the radiation detector are automatically connected to each other. Therefore, in some cases, the radiation detector and the imaging device desired by the user are not connected to each other.

The present disclosure has been made in view of the above-mentioned problems, and an object of the present disclosure is to provide an information processing device, a radiation detector, an information processing method, and an information processing program that enable an easy connection to a desired connection destination by wireless communication.

In order to achieve the above object, according to a first aspect of the present disclosure, there is provided an information processing device comprising at least one processor that is provided in a housing of a radiation detector which is capable of performing wireless communication. The processor receives an instruction to change a connection destination of the wireless communication which is input by operating an operation button that is provided in the housing to input the instruction to change the connection destination, specifies a connection destination corresponding to the change instruction from a plurality of preset connection destinations in a case in which the change instruction is received, determines whether or not a connection to the plurality of connection destinations by the wireless communication is possible, and performs control to display information indicating that the connection is not possible on a display unit provided in the housing in a case in which it is determined that the connection to the specified connection destination by the wireless communication is not possible.

According to a second aspect of the present disclosure, in the information processing device according to the first aspect, the processor may further receive a connection decision instruction input by operating a decision button that is provided in the housing to decide the connection to the connection destination corresponding to the change instruction and may be connected to the specified connection destination by the wireless communication in a case in which the decision instruction is received and it is determined that the connection to the specified connection destination by the wireless communication is possible.

According to a third aspect of the present disclosure, in the information processing device according to the first aspect, in a case in which it is determined that the connection to the specified connection destination by the wireless communication is possible, the processor may be connected to the specified connection destination by the wireless communication.

According to a fourth aspect of the present disclosure, in the information processing device according to any one of the first to third aspects, the change instruction may include a shift instruction to shift to a wireless communication connection destination change mode and a connection destination instruction indicating a connection destination which is a change destination selected from the plurality of connection destinations after the instruction to shift to the change mode, and the processor may specify a connection destination corresponding to the connection destination instruction from the plurality of connection destinations.

According to a fifth aspect of the present disclosure, in the information processing device according to the fourth aspect, the processor may determine whether or not the connection to each of the plurality of connection destinations by the wireless communication is possible in a case in which the shift instruction is received and may determine whether or not the connection to the connection destination corresponding to the connection destination instruction by the wireless communication is possible on the basis of a result of determining whether or not the connection to each of the plurality of connection destinations by the wireless communication is possible in a case in which the connection destination instruction is received.

According to a sixth aspect of the present disclosure, in the information processing device according to any one of the first to fourth aspects, the processor may repeatedly determine whether or not the connection to each of the plurality of connection destinations by the wireless communication is possible at a predetermined timing.

According to a seventh aspect of the present disclosure, in the information processing device according to any one of the first to fourth aspects, the processor may determine whether or not the connection to the specified connection destination among the plurality of connection destinations by the wireless communication is possible.

According to an eighth aspect of the present disclosure, in the information processing device according to any one of the first to seventh aspects, there may be a plurality of types of the connection destinations, the display unit may have a type display unit indicating the plurality of types, and the processor may further perform control to display information indicating the type of the specified connection destination on the type display unit.

According to a ninth aspect of the present disclosure, in the information processing device according to any one of the first to eighth aspects, the processor may further perform control to display information on a connection destination to which the connection by the wireless communication is determined to be possible and the display unit in the same display aspect.

According to a tenth aspect of the present disclosure, there is provided a radiation detector comprising: a wireless communication unit; a radiation detection unit that generates image data indicating a radiographic image corresponding to emitted radiation; a housing that accommodates the radiation detection unit; and the information processing device according to the present disclosure.

Further, in order to achieve the above object, according to an eleventh aspect of the present disclosure, there is provided an information processing method comprising causing a processor, which is provided in a housing of a radiation detector that is capable of performing wireless communication, to perform a process including: receiving an instruction to change a connection destination of the wireless communication which is input by operating an operation button that is provided in the housing to input the instruction to change the connection destination, specifying a connection destination corresponding to the change instruction from a plurality of preset connection destinations in a case in which the change instruction is received, determining whether or not a connection to the plurality of connection destinations by the wireless communication is possible, and performing control to display information indicating that the connection is not possible on a display unit provided in the housing in a case in which it is determined that the connection to the specified connection destination by the wireless communication is not possible.

Furthermore, in order to achieve the above object, according to a twelfth aspect of the present disclosure, there is provided an information processing program that causes a processor, which is provided in a housing of a radiation detector that is capable of performing wireless communication, to perform a process comprising: receiving an instruction to change a connection destination of the wireless communication which is input by operating an operation button that is provided in the housing to input the instruction to change the connection destination; specifying a connection destination corresponding to the change instruction from a plurality of preset connection destinations in a case in which the change instruction is received; determining whether or not a connection to the plurality of connection destinations by the wireless communication is possible; and performing control to display information indicating that the connection is not possible on a display unit provided in the housing in a case in which it is determined that the connection to the specified connection destination by the wireless communication is not possible.

According to the present disclosure, the radiation detector can be easily connected to a desired connection destination by wireless communication.

### BRIEF DESCRIPTION OF THE DRAWINGS

Exemplary embodiments according to the technique of the present disclosure will be described in detail based on the following figures, wherein:

FIG. 1 is a diagram illustrating an example of a radiography system,

FIG. 2 is a block diagram illustrating an example of a hardware configuration of a radiation detector and a console according to a first embodiment,

FIG. 3 is a diagram illustrating an example of connection destination information according to the embodiment,

FIG. 4 is a diagram illustrating an example of a display unit and operation buttons provided on a rear surface of a housing of the radiation detector,

FIG. 5 is a diagram illustrating an example of the display unit,

FIG. 6 is a functional block diagram illustrating an example of a functional configuration of the radiation detector according to the first embodiment,

FIG. 7 is a flowchart illustrating an example of the flow of a connection process in the radiation detector according to the first embodiment,

FIG. 8 is a diagram illustrating a specific example of the connection process according to the embodiment,

FIG. 9A is a diagram illustrating an example of a display aspect of the display unit,

FIG. 9B is a diagram illustrating an example of the display aspect of the display unit,

FIG. 9C is a diagram illustrating an example of a display aspect of a 7-segment display,

FIG. 10 is a flowchart illustrating an example of the flow of a connection process in a radiation detector according to Modification Example 1,

FIG. 11 is a flowchart illustrating an example of the flow of a connection process in a radiation detector according to a second embodiment, and

FIG. 12 is a flowchart illustrating an example of the flow of a determination process in a radiation detector according to Modification Example 2.

### DETAILED DESCRIPTION

Hereinafter, embodiments of the present disclosure will be described in detail with reference to the drawings. In addition, each of the embodiments does not limit the present disclosure.

### First Embodiment

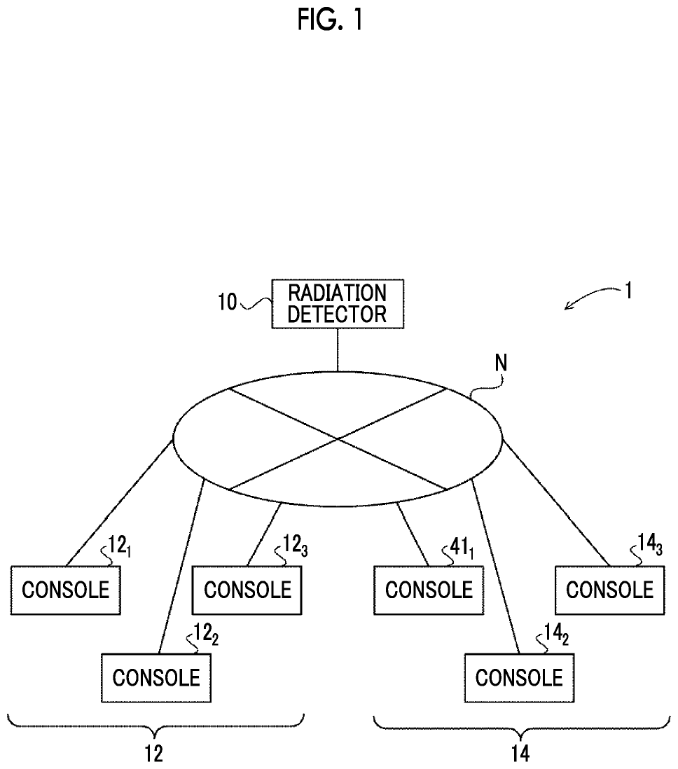

First, the configuration of a radiography system 1 according to this embodiment will be described with reference to FIG. 1. As illustrated in FIG. 1, the radiography system 1 according to this embodiment comprises a radiation detector 10, a plurality of consoles 12 (three consoles 12₁ to 12₃ in FIG. 1), and a plurality of consoles 14 (three consoles 14₁ to 14₃ in FIG. 1). The radiation detector 10, the consoles 12₁ to 12₃, and the consoles 14₁ to 14₃ are connected to a network N by wireless communication such that they can communicate with each other. In addition, the radiography system 1 according to this embodiment includes three consoles 12 and three consoles 14 as illustrated in FIG. 1. However, the numbers of consoles 12 and consoles 14 included in the radiography system 1 are not particularly limited. The consoles 12 and the consoles 14 according to this embodiment are an example of a “plurality of preset connection destinations” according to the present disclosure.

The radiation detector 10 has a function of outputting a radiographic image corresponding to emitted radiation. Specifically, the radiation detector 10 has a function of generating image data indicating a radiographic image corresponding to the radiation which has been emitted from a radiation source (not illustrated) and transmitted through a subject and outputting the image data. The radiation detector 10 according to this embodiment is a so-called flat panel detector (FPD).

Each of the consoles 12 and the consoles 14 is connected to a radiology information system (RIS) (not illustrated) wirelessly or in a wired manner and has a function of independently controlling the radiation detector 10 on the basis of, for example, an imaging order received from the RIS to control the capture of a radiographic image by the radiation detector 10. Each of the plurality of consoles 12 is a stationary console and is installed in, for example, a radiography room. Further, each of the plurality of consoles 14 is a mobile console and is provided in, for example, a nursing cart. The consoles 12 and the consoles 14 according to this embodiment are an example of a “plurality of connection destinations” according to the present disclosure.

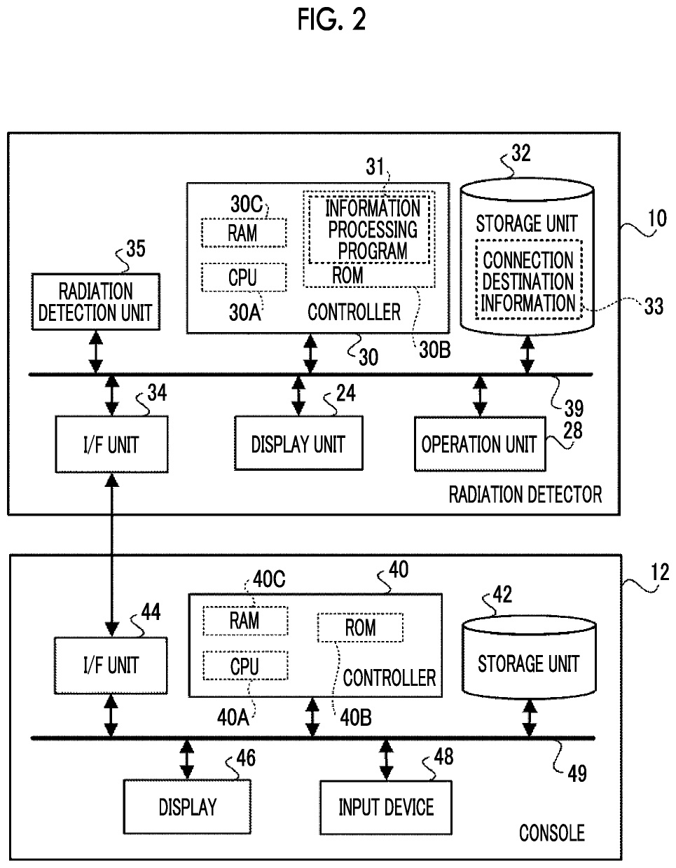

FIG. 2 is a block diagram illustrating an example of the hardware configuration of the radiation detector 10, the console 12, and the console 14 according to this embodiment. In addition, the hardware configuration of one console 12 is illustrated, and an example of the configuration of the console 12 will be described below. However, the hardware configurations of the plurality of consoles 12 and the plurality of consoles 14 are substantially the same as the configuration of the console 12 illustrated in FIG. 2.

As illustrated in FIG. 2, the console 12 according to this embodiment comprises a controller 40, a storage unit 42, an I/F unit 44, a display 46, and an input device 48. The controller 40, the storage unit 42, the I/F unit 44, the display 46, and the input device 48 are connected to each other through a bus 49, such as a system bus or a control bus, such that they can transmit and receive various kinds of information.

The controller 40 according to this embodiment controls the overall operation of the console 12. The controller 40 comprises a central processing unit (CPU) 40A, a read only memory (ROM) 40B, and a random access memory (RAM) 40C. The ROM 40B stores in advance a program, such as an imaging control processing program (not illustrated) for controlling the capture of a radiographic image by the console 12, which is executed by the CPU 40A. The RAM 40C temporarily stores various kinds of data.

For example, image data of the radiographic image captured by the radiation detector 10 and various other kinds of information are stored in the storage unit 42. A specific example of the storage unit 42 is a hard disk drive (HDD) or a solid state drive (SSD).

The I/F unit 44 transmits and receives various kinds of information to and from the radiation detector 10 through the network N using wireless communication. In the radiography system 1 according to this embodiment, the console 12 receives the image data of the radiographic image captured by the radiation detector 10 from the radiation detector 10 through the I/F unit 44 using wireless communication. In addition, the I/F unit 44 may further perform wired communication with the radiation detector 10. The I/F unit 44 transmits and receives various kinds of information to and from the RIS or a picture archiving and communication system (PACS) using wireless communication or wired communication.

The display 46 displays various kinds of information including an imaging order related to, for example, the capture of a radiographic image by the radiation detector 10, the radiographic image captured by the radiation detector 10, or the like. The input device 48 is used by the user to input instructions related to the capture of a radiographic image, such as the designation of an imaging menu corresponding to an imaging order, or various kinds of information. The input device 48 is not particularly limited. Examples of the input device 48 include various switches, a touch panel, a touch pen, and a mouse. In addition, the display 46 and the input device 48 may be integrated into a touch panel display.

Further, as illustrated in FIG. 2, the radiation detector 10 according to this embodiment comprises a display unit 24, operation buttons 28, a controller 30, a storage unit 32, an I/F unit 34, and a radiation detection unit 35. The display unit 24, the operation buttons 28, the controller 30, the storage unit 32, the I/F unit 34, and the radiation detection unit 35 are connected to each other through a bus 39, such as a system bus or a control bus, such that they can transmit and receive various kinds of information.

The controller 30 according to this embodiment controls the overall operation of the radiation detector 10. The controller 30 comprises a CPU 30A, a ROM 30B, and a RAM 30C. A program, such as an information processing program 31, executed by the CPU 30A is stored in the ROM 30B in advance. The RAM 30C temporarily stores various kinds of data. The CPU 30A according to this embodiment is an example of a “processor” according to the present disclosure and is also an example of an “information processing device” according to the present disclosure.

In the radiation detection unit 35, a plurality of pixels that generates signal charge in response to radiation or visible light converted from radiation by a conversion layer, such as a scintillator, are arranged. The radiation detection unit 35 has a function of generating image data indicating a radiographic image corresponding to the emitted radiation.

The storage unit 32 stores, for example, the image data of the radiographic image captured by the radiation detector 10, connection destination information 33 related to a connection destination of wireless communication, and various other kinds of information. A specific example of the storage unit 32 is an HDD or an SSD.

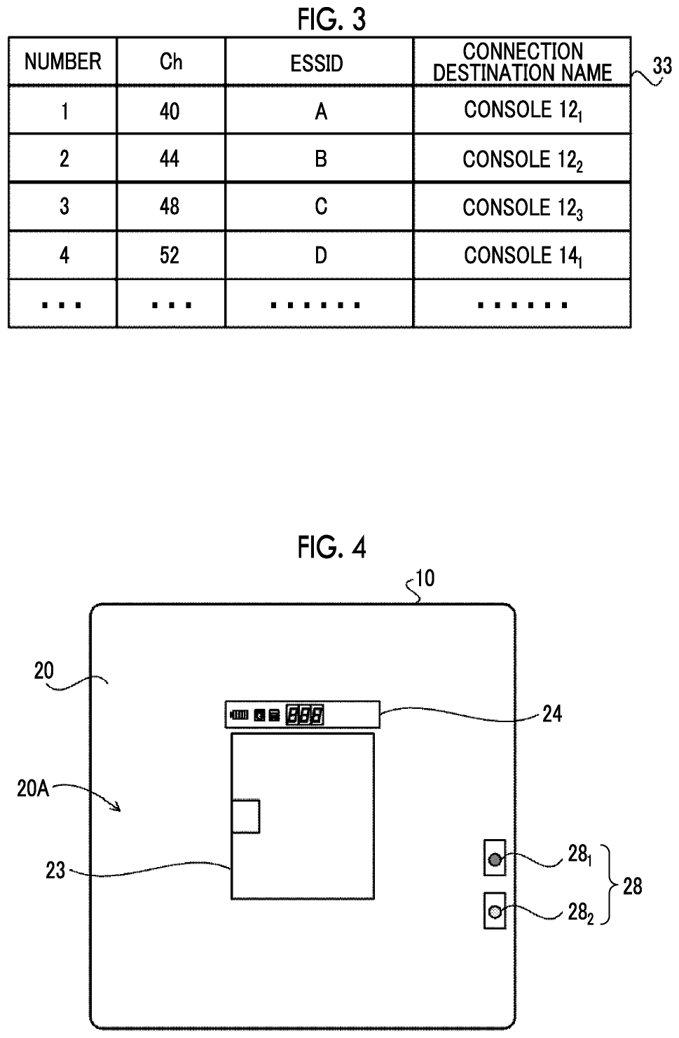

FIG. 3 illustrates an example of the connection destination information 33 according to this embodiment. In the radiography system 1 according to this embodiment, it is possible to register up to n connection destinations of the radiation detector 10 in advance. The n connection destinations are associated with connection destination identification numbers 1 to n, respectively, and information required for wireless communication with the radiation detector 10 is stored as the connection destination information 33 in the storage unit 32. As illustrated in FIG. 3, in this embodiment, a communication channel (Ch), an extended service set identifier (ESSID), a communication destination name, and a communication system or a communication standard of, for example, IEEE are applied as the information required for wireless communication with the radiation detector 10. However, the information required for wireless communication is not limited thereto. The information required for wireless communication may be any information as long as it is required to specify the connection destination, and may be, for example, only the communication channel and the ESSID. As described above, in the radiography system 1 according to this embodiment, the consoles 12₁ to 12₃ and the consoles 14₁ to 14₃ are the connection destinations of the radiation detector 10. Therefore, for example, the channel and ESSID of the console 12₁ are associated with connection destination identification number 1, the channel and ESSID of the console 12₂ are associated with connection destination identification number 2, the channel and ESSID of the console 12₃ are associated with connection destination identification number 3, the channel and ESSID of the console 14₁ are associated with connection destination identification number 4, the channel and ESSID of the console 14₂ are associated with connection destination identification number 5, and the channel and ESSID of the console 14₃ are associated with connection destination identification number 6. In addition, for example, the information may further include a connection destination type in wireless communication or a connection destination mode corresponding to the connection destination type (not illustrated in FIG. 3), which will be described in detail below.

In this embodiment, the console, such as the console 12 or the console 14, sets the connection destination to the connection destination information 33. Specifically, the console can perform various kinds of settings, such as the addition of a new connection destination to the connection destination information 33, a change in information related to the set connection destination, and the deletion of the connection destination. In addition, in a case in which the connection destination information 33 has not yet been stored in the storage unit 32, such as in a case in which the radiation detector 10 is used for the first time, or in a case in which the connection destination has not yet been set in the connection destination information 33 stored in the storage unit 32, for example, the console connected to the radiation detector 10 by wired communication may perform initial settings related to the connection destination information 33.

The I/F unit 34 transmits and receives various kinds of information to and from the console 12 (console 14) through the network N using wireless communication. In the radiography system 1 according to this embodiment, the image data of the radiographic image generated by the radiation detection unit 35 is transmitted to the console 12 or the console 14 through the I/F unit 34 by wireless communication. In addition, the I/F unit 34 may further perform wired communication with the console 12 or the console 14.

The display unit 24 displays various kinds of information related to, for example, the capture of radiographic images by the radiation detection unit 35. The operation buttons 28 are used by the user to input an instruction related to, for example, the capture of radiographic images. In the radiation detector 10 according to this embodiment, the controller 30, the storage unit 32, the I/F unit 34, and the radiation detection unit 35 are provided in a housing 20. For example, as illustrated in FIG. 4, the display unit 24 and the operation buttons 28 are provided on a rear surface 20A of the housing 20 which is opposite to a surface irradiated with radiation.

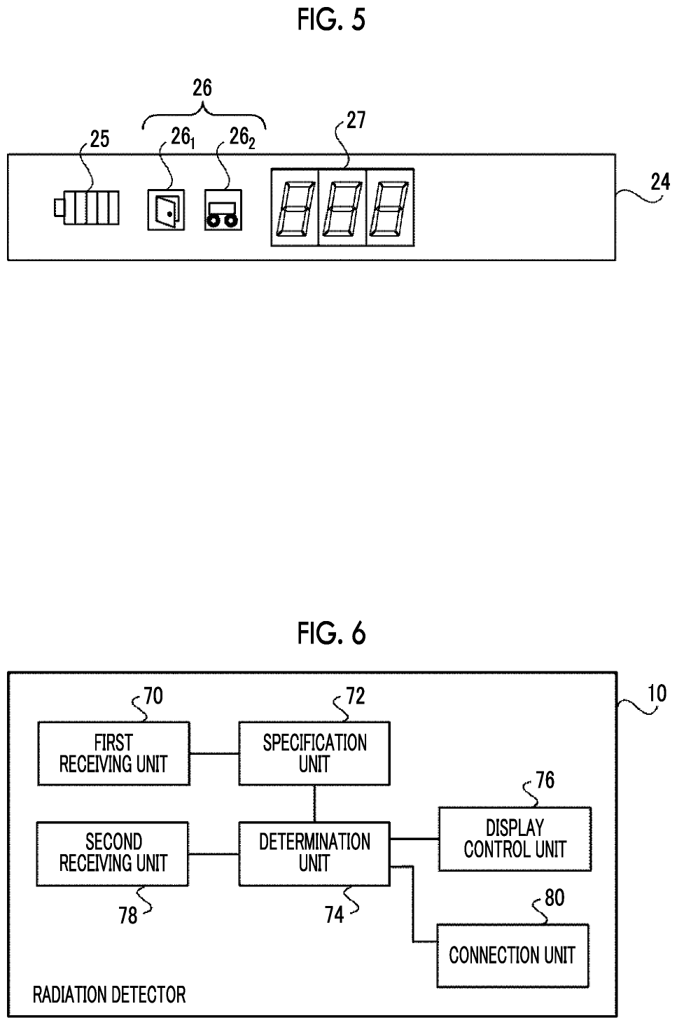

As illustrated in FIG. 4, the display unit 24 according to this embodiment is provided in the vicinity of a battery 23 and is composed of light emitting diodes (LEDs). For example, the display unit 24 according to this embodiment includes a remaining battery level display unit 25, a connection destination mode display unit 26, and a 7-segment display 27 as illustrated in FIG. 5. The remaining battery level display unit 25 has a function of displaying the remaining battery level status of the battery 23.

The connection destination mode display unit 26 includes icons 26₁ and 26₂ indicating connection destination modes corresponding to the types of connection destinations in wireless communication. The radiation detector 10 according to this embodiment has a plurality of connection destination modes corresponding to the types of connection destinations in wireless communication. For example, as described above, in the radiography system 1 according to this embodiment, the console 12 or the console 14 is present as the connection destination of the radiation detector 10 by wireless communication. Therefore, there are two types of connection destinations, and there are two types of connection destination modes. In the case of the connection destination mode in which the radiation detector 10 is connected to the stationary console, such as the console 12, by wireless communication, the icon 26₁ of the connection destination mode display unit 26 is turned on. Further, in the case of the connection destination mode in which the radiation detector 10 is connected to the mobile console, such as the console 14, by wireless communication, the icon 26₂ of the connection destination mode display unit 26 is turned on. The connection destination mode display unit 26 according to this embodiment is an example of a “type display unit” according to the present disclosure.

The 7-segment display 27 has a function of displaying information indicating the connection destination by wireless communication. For example, in this embodiment, the connection destination identification number associated with the connection destination is applied as the information indicating the connection destination. Therefore, the connection destination identification number indicating the connection destination connected to the radiation detector 10 by wireless communication is displayed on the 7-segment display 27. Specifically, in a case in which the user sets the connection destination, the connection destination identification number indicating the connection destination is displayed. In addition, in this embodiment, the 7-segment display is adopted as an example of the display unit that displays information indicating the connection destination by wireless communication. However, the present disclosure is not limited to the 7-segment display 27. For example, a display unit of another type, such as a flat display, may be adopted.

Further, as illustrated in FIG. 4, the operation buttons 28 according to this embodiment are provided in the vicinity of the outer edge of the rear surface 20A of the housing 20. For example, the operation buttons 28 according to this embodiment include operation buttons 28₁ and 28₂ as illustrated in FIG. 4.

In this embodiment, in a case in which the user changes the connection destination of wireless communication, first, the user operates the operation buttons 28 to input an instruction to shift to a change mode for changing the connection destination of the wireless communication. For example, in this embodiment, in a case in which the user operates both the operation buttons 28₁ and 28₂ at the same time, the radiation detector 10 is shifted to the change mode for changing the connection destination of the wireless communication. In this case, the operation buttons 28₁ and 28₂ according to this embodiment are an example of “operation buttons” that are operated to perform a “shift instruction” according to the present disclosure.

Then, the user operates the operation buttons 28 to select the connection destination of the wireless communication. For example, in this embodiment, whenever the user operates the operation button 28₂, the connection destination identification number displayed on the 7-segment display 27 is sequentially switched. Therefore, the user repeatedly operates the operation button 28₂ to display the connection destination identification number corresponding to the console 12 or the console 14 to be connected on the 7-segment display 27. The operation button 28₂ is an example of an “operation button” that is operated to perform a connection destination instruction according to the present disclosure.

Further, the user operates the operation button 28 to decide the connection of the console 12 or the console 14 corresponding to the connection destination identification number displayed on the 7-segment display 27. For example, in this embodiment, the user operates the operation button 28₁ to decide the connection destination by the wireless communication. In this case, the operation button 28₁ according to this embodiment is an example of a “decision button” according to the present disclosure.

In addition, FIG. 6 is a functional block diagram illustrating an example of the configuration of the radiation detector 10 according to this embodiment. As illustrated in FIG. 6, the radiation detector 10 comprises a first receiving unit 70, a specification unit 72, a determination unit 74, a display control unit 76, a second receiving unit 78, and a connection unit 80. For example, in the radiation detector 10 according to this embodiment, the CPU 30A of the controller 30 executes the information processing program 31 stored in the ROM 30B to function as the first receiving unit 70, the specification unit 72, the determination unit 74, the display control unit 76, the second receiving unit 78, and the connection unit 80.

The first receiving unit 70 has a function of receiving a connection destination change instruction input by operating the operation buttons 28 provided in the housing 20 in order to input an instruction to change the connection destination of the wireless communication. As described above, the user operates both the operation buttons 28₁ and 28₂ at the same time to input the instruction to shift to the change mode for changing the connection destination of the wireless communication. In a case in which both the operation buttons 28₁ and 28₂ are operated at the same time, the first receiving unit 70 receives a shift instruction to shift to the change mode. Further, as described above, the user operates the operation button 28₂ to display the connection destination identification number indicating the console 12 or the console 14 to be connected to the radiation detector 10 on the 7-segment display 27. In a case in which the operation button 28₂ is operated independently after the first receiving unit 70 receives the shift instruction, the first receiving unit 70 receives a connection destination instruction indicating the connection destination which is a change destination selected from a plurality of connection destinations. The first receiving unit 70 outputs each of the received shift instruction and connection destination instruction to the specification unit 72. In addition, in a case in which the shift instruction and the connection destination instruction received by the first receiving unit 70 are collectively called, they are referred to as a change instruction.

The specification unit 72 has a function of specifying a connection destination corresponding to the change instruction from the consoles 12 and the consoles 14 preset in the connection destination information 33 in a case in which the first receiving unit 70 receives the change instruction. The specification unit 72 outputs information indicating the specified connection destination to the determination unit 74.

The determination unit 74 determines whether or not the radiation detector 10 can be connected to the consoles 12 and the consoles 14 by wireless communication. In this embodiment, the determination unit 74 determines whether or not the radiation detector 10 can be connected to the console 12 or the console 14, which corresponds to the information indicating the connection destination input from the specification unit 72, among the consoles 12 and the consoles 14 by wireless communication. In addition, the method by which the determination unit 74 determines whether or not the connection is possible by wireless communication through the I/F unit 34 is not particularly limited. The determination unit 74 outputs the determination result to the display control unit 76 and the connection unit 80.

The display control unit 76 has a function of performing control to display information indicating that the connection is not possible on the 7-segment display 27 provided in the housing 20 in a case in which the determination result input from the determination unit 74 shows that the connection to the connection destination specified by the specification unit 72 by wireless communication is not possible.

The second receiving unit 78 has a function of receiving a connection decision instruction input by operating the operation button 28 provided in the housing 20 in order to decide the connection to the connection destination corresponding to the change instruction. As described above, the user operates the operation button 28₁ to decide the connection destination by wireless communication. In a case in which the operation button 28₁ is operated, the second receiving unit 78 receives the decision instruction to decide the connection to the connection destination corresponding to the connection destination instruction. The second receiving unit 78 outputs the received decision instruction to the determination unit 74.

The connection unit 80 has a function of being connected to the connection destination specified by the specification unit 72 through the I/F unit 34 by wireless communication in a case in which the second receiving unit 78 receives the decision instruction and the determination unit 74 determines that the connection by wireless communication is possible.

Next, the operation of the radiation detector 10 according to this embodiment will be described with reference to the drawings.

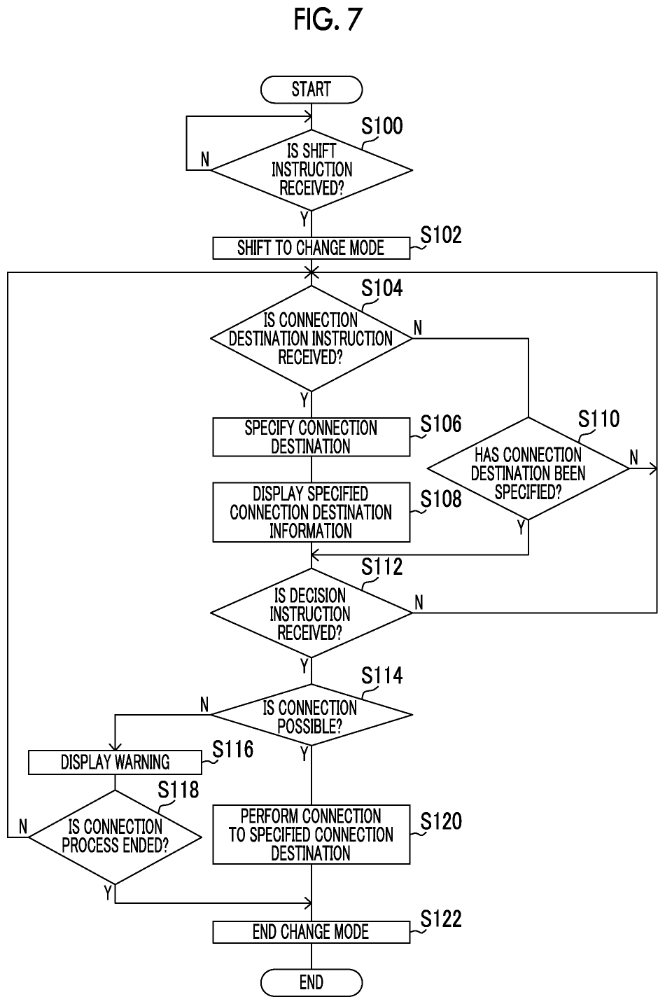

In the radiation detector 10 according to this embodiment, the CPU 30A of the controller 30 executes the information processing program 31 stored in the ROM 30B to perform a connection process whose example is illustrated in FIG. 7. FIG. 7 is a flowchart illustrating an example of the flow of the connection process performed in the radiation detector 10 according to this embodiment. In this embodiment, for example, in a case in which the operation button 28 is operated, the connection process illustrated in FIG. 7 is performed. In addition, the timing when the connection process illustrated in FIG. 7 is performed is not limited to this embodiment. For example, the connection process may be performed at the timing when the radiation detector 10 is turned on.

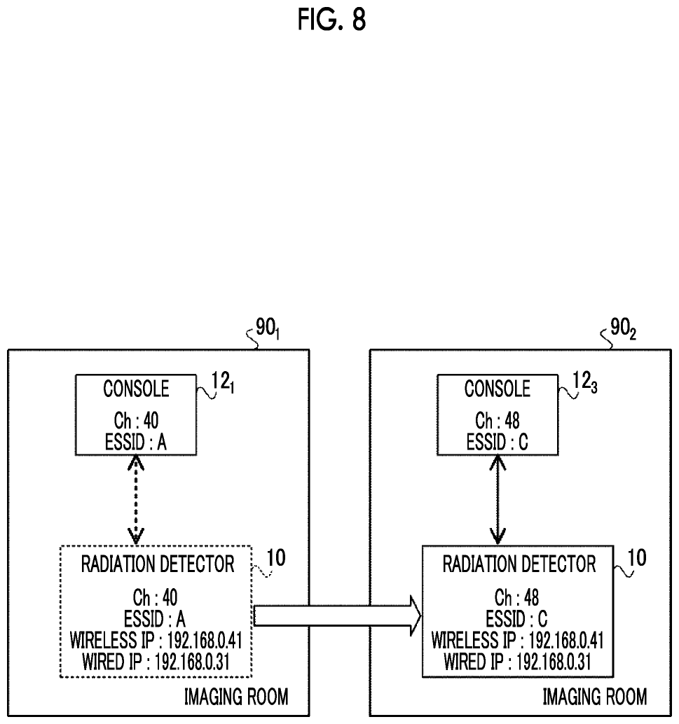

As a specific example, a case in which the radiation detector 10 used in an imaging room 90₁ in which the console 12₁ is installed is moved to an imaging room 90₂ in which the console 12₃ is installed and is then used as illustrated in FIG. 8 will be described below. In the example illustrated in FIG. 8, in the imaging room 90ₖ, the radiation detector 10 is connected to the console 12₁ by wireless communication and captures radiographic images under the control of the console 12ₖ. Further, in the imaging room 90₂, the radiation detector 10 is connected to the console 12₃ by wireless communication and captures radiographic images under the control of the console 12₃.

In Step S100 of FIG. 7, the specification unit 72 determines whether or not the first receiving unit 70 receives the shift instruction. In the example illustrated in FIG. 8, in a case in which the user moves the radiation detector 10 from the imaging room 90₁ to the imaging room 90₂, the user operates the operation buttons 28₁ and 28₂ to input an instruction to shift to the change mode for changing the connection destination of wireless communication in order to change the connection destination of the radiation detector 10 from the console 12₁ to the console 12₃. In a case in which the operation buttons 28₁ and 28₂ are operated, the first receiving unit 70 receives the shift instruction. The determination result in Step S100 is “No” until the first receiving unit 70 receives the shift instruction. On the other hand, in a case in which the first receiving unit 70 receives the shift instruction, the determination result in Step S100 is “Yes”, and the process proceeds to Step S102.

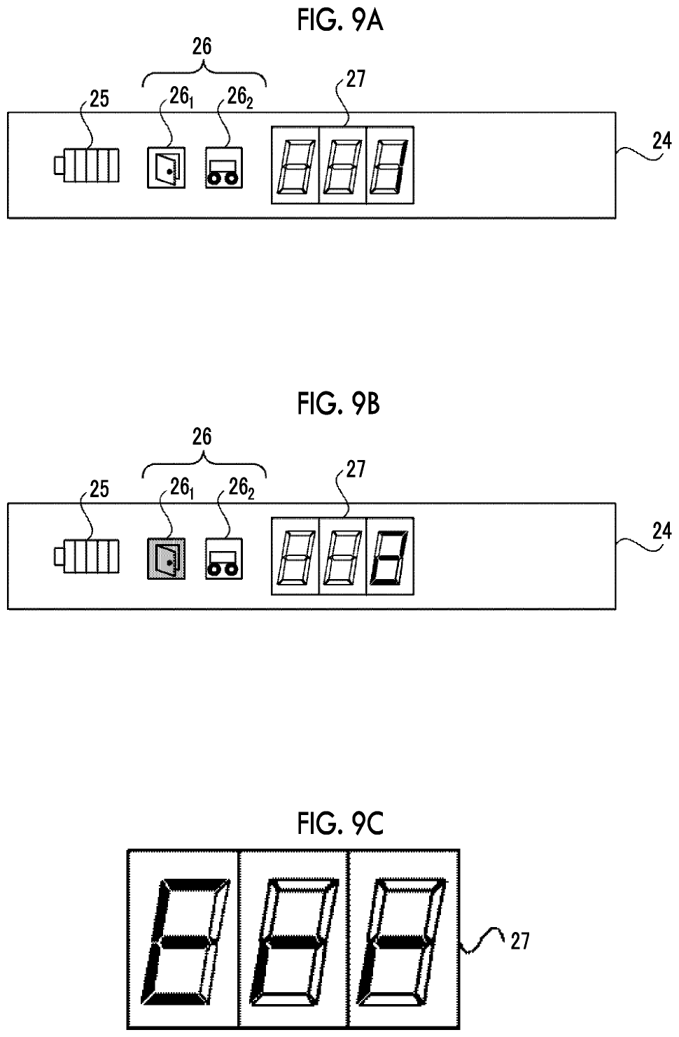

In Step S102, the specification unit 72 shifts the mode to the change mode for changing the connection destination of the radiation detector 10 by wireless communication. In addition, in a case in which the mode is shifted to the change mode, information indicating the connection destination to which the radiation detector is currently being connected is displayed on the 7-segment display 27. In this case, for example, a connection destination identification number indicating the connection destination to which the radiation detector is currently being connected is displayed. In the example illustrated in FIG. 8, since the connection destination to which the radiation detector is currently being connected is the console 12ₖ, “1” which is the connection destination identification number indicating the console 12₁ may be displayed on the 7-segment display 27 with reference to the connection destination information 33 (see FIG. 3) as illustrated in FIG. 9A.

Then, in Step S104, the specification unit 72 determines whether or not the first receiving unit 70 receives the connection destination instruction. As described above, in a case in which the operation button 28₂ is operated independently, the first receiving unit 70 receives the connection destination instruction. In a case in which the first receiving unit 70 receives the connection destination instruction, the determination result in Step S104 is “Yes”, and the process proceeds to Step S106.

In Step S106, the specification unit 72 specifies a connection destination corresponding to the instruction. For example, as described above, in a case in which the information indicating the connection destination to which the radiation detector is currently being connected is displayed on the 7-segment display 27 in Step S102, the specification unit 72 specifies a connection destination corresponding to a connection destination identification number which corresponds to the connection destination identification number corresponding to the connection destination, to which the radiation detector is currently being connected, and the number of times the operation button 28₂ is operated independently.

In a case in which the operation button 28₂ is operated independently for the first time, that is, in a case in which the number of operations is one, the connection destination, with which a number obtained by adding “1” which is the number of operations to the connection destination identification number corresponding to the connection destination to which the radiation detector is being currently connected is associated as the connection destination identification number, is specified with reference to the connection destination information 33. In the example illustrated in FIG. 8, the specification unit 72 specifies the console 12₂ with which a number “2” obtained by adding “1” which is the number of operations to “1” which is the connection destination identification number corresponding to the console 12₁ that is the connection destination to which the radiation detector is being currently connected is associated as the connection destination identification number.

Then, in Step S108, the specification unit 72 displays connection destination information indicating the specified connection destination on the display unit 24 and then proceeds to Step S112. For example, the specification unit 72 according to this embodiment blinks the connection destination mode display unit 26, specifically, the icon 26₁ or the icon 26₂ corresponding to the type of the specified connection destination. As in the above-mentioned example, in a case in which the specified connection destination is the console 12₂, the specification unit 72 blinks the icon 26₁ corresponding to the type of the console 12₂ as illustrated in FIG. 9B. In addition, in FIG. 9B, the blinking of the display is represented by hatching.

Further, the specification unit 72 displays the connection destination identification number corresponding to the specified connection destination on the 7-segment display 27. As in the above-mentioned example, in a case in which the specified connection destination is the console 12₂, the specification unit 72 displays the connection destination identification number “2” on the 7-segment display 27.

In a case in which the first receiving unit 70 does not receive the connection destination instruction, the determination result in Step S104 is “No”, and the process proceeds to Step S110. In Step S110, the specification unit 72 determines whether or not the connection destination has been specified. In a case in which the user has not yet operated the operation button 28₂ independently after the start of the connection process illustrated in FIG. 7, the determination result in Step S110 is “No”, and the process returns to Step S104. On the other hand, in a case in which the process in Step S108 has been performed, the determination result in Step S110 is “Yes”, and the process proceeds to Step S112.

Then, in Step S112, the determination unit 74 determines whether or not the second receiving unit 78 receives the decision instruction. In the example illustrated in FIG. 8, the user changes the connection destination of the radiation detector 10 to the console 12₃ as described above. Therefore, in a case in which the display illustrated in FIG. 9B is displayed on the display unit 24, the user has not yet input the decision instruction. In this case, the determination result in Step S112 is “No”, the process returns to Step S104, and the processes in Steps S104 to S110 are repeated.

On the other hand, in a case in which the user repeatedly operates the operation button 28₂ independently to display the connection destination identification number indicating the connection destination to be connected to the radiation detector 10 on the 7-segment display 27, the user operates the operation button 28₁ independently to decide the connection destination. In a case in which the operation button 28₁ is operated independently, the second receiving unit 78 receives the decision instruction. Therefore, the determination result in Step S112 is “Yes”, and the process proceeds to Step S114.

In Step S114, the determination unit 74 determines whether or not a connection to the connection destination specified in Step S106 by wireless communication is possible. In other words, the determination unit 74 determines whether or not the connection to the connection destination selected by the operation of the operation button 28₁ by the user by wireless communication is possible. Specifically, the determination unit 74 acquires the communication channel and the ESSID corresponding to the specified connection destination with reference to the connection destination information 33 and applies the acquired communication channel and ESSID to determine whether or not the connection is possible by wireless communication through the OF unit 34. In a case in which the connection is not possible, the determination result in Step S114 is “No” and the process proceeds to Step S116. For example, in the example illustrated in FIG. 8, in a case in which the user operates the operation button 28 to decide connection to the console 12₃ while the user is in the imaging room 90ₖ, radio waves from the console 12₃ may not be reached by wireless communication since the radiation detector 10 is still located at a position away from the console 12₃. In this case, the determination result in Step S114 is “No”, and the process proceeds to Step S116. Further, for example, even in a case in which radio waves are not reached by wireless communication due to an error in the selected console 12, the determination result in Step S114 is “No”.

In Step S116, the display control unit 76 performs control to display a warning as information indicating that the connection to the selected connection destination is not possible on the 7-segment display 27. FIG. 9C illustrates an example of a display aspect in which a warning is displayed on the 7-segment display 27. In the example illustrated in FIG. 9C, a display aspect in a case in which characters “Err” indicating an error are displayed as the warning on the 7-segment display 27 is illustrated. In addition, the warning displayed on the 7-segment display 27 is not limited to the aspect illustrated in FIG. 9C. For example, an identification number corresponding to the error may be displayed on the 7-segment display 27. Further, in a case in which the warning is displayed on the 7-segment display 27, it is preferable that the display aspect is different from that in a case in which other information, such as a connection destination identification number indicating the connection destination selected by the user, is displayed. For example, the different display aspects include the display of the warning in a different color and whether or not the warning is blinked. The display of the warning on the 7-segment display 27 makes it possible for the user to recognize that the connection to the selected connection destination by wireless communication is not possible.

Then, in Step S118, the determination unit 74 determines whether or not to end the connection process. In this embodiment, in a case in which predetermined end conditions are satisfied, the determination unit 74 determines to end the connection process. An example of the predetermined end conditions is a case in which, even after a predetermined time has elapsed since the second receiving unit 78 received the decision instruction, the connection to the connection destination specified in Step S106 by wireless communication is not possible. Further, an example of the predetermined end conditions is a case in which the user inputs an instruction to end the connection process. The user operates the operation button 28 to input the instruction to end the connection process, for example, in a case in which the radiation detector 10 different from the radiation detector 10 to be used is used and is not capable of being connected to the console 12 used for imaging or in a case in which the connection by wireless communication is not possible since the radio wave conditions of the wireless communication are poor even though a combination of the radiation detector 10 and the console 12 is appropriate. For example, in this embodiment, the user pushes and holds both the operation buttons 28₁ and 28₂ at the same time to input the instruction to end the connection process.

In a case in which the connection process is not ended, in other words, in a case in which the predetermined end conditions are not satisfied, the determination result in Step S118 is “No”, and the process returns to Step S104. Then, the above-mentioned processes are repeated. On the other hand, in a case in which the connection process is ended, in other words, in a case in which the predetermined end conditions are satisfied, the determination result in Step S118 is “Yes”, and the process proceeds to Step S122.

On the other hand, in a case in which the determination unit 74 determines that the connection to the connection destination specified in Step S106 by wireless communication is possible, the determination result in Step S114 is “Yes”, and the process proceeds to Step S120. In the example illustrated in FIG. 8, in a case in which the radiation detector 10 is moved into the imaging room 90₂, the determination unit 74 determines that the connection by wireless communication is possible.

In Step S120, the connection unit 80 is connected to the connection destination specified in Step S106 through the I/F unit 34 by wireless communication. In the example illustrated in FIG. 8, the connection unit 80 connects the radiation detector 10 and the console 12₃ using wireless communication. In addition, in a case in which the connection by wireless communication is completed, the connection unit 80 may display information indicating that the connection has been completed on the display unit 24. For example, a code or a message indicating that the connection has been completed may be displayed on the 7-segment display 27.

Then, in Step S122, the specification unit 72 ends the change mode shifted by the process in Step S102. For example, in this embodiment, in a case in which the change mode is ended, the mode is shifted to an imaging mode corresponding to a case in which radiography is performed. In a case in which the process in Step S122 ends, the connection process illustrated in FIG. 7 ends.

As described above, in the radiation detector 10 according to this embodiment, in a case in which the instruction to change the connection destination input by the user through the operation button 28 provided in the housing 20 is received, a connection destination corresponding to the change instruction is specified from the plurality of consoles 12 and consoles 14, and the connection destination identification number indicating the specified connection destination is displayed on the 7-segment display 27. In addition, in a case in which the instruction to decide the connection destination selected by the user is received, it is determined whether or not the connection to the selected connection destination by wireless communication is possible. In a case in which it is determined that the connection is not possible, control is performed such that a warning indicating that the connection is not possible is displayed on the 7-segment display 27 of the display unit 24 provided in the housing 20.

Therefore, according to this embodiment, the radiation detector 10 can be easily connected to a desired connection destination by wireless communication. Further, the user only needs to check the warning displayed on the 7-segment display 27 of the display unit 24 in the housing 20. Therefore, it is possible to easily check that the connection by wireless communication is not possible.

### Modification Example 1

In the above-described embodiment, the following aspect has been described: in a case in which the second receiving unit 78 receives the decision instruction, the determination unit 74 determines whether or not the connection to the selected connection destination by wireless communication is possible; and, in a case in which the connection is possible, the connection unit 80 is connected to the selected connection destination by wireless communication. In contrast, in this modification example, an aspect will be described in which the radiation detector is automatically connecting to the selected connection destination by wireless communication, without receiving the decision instruction.

A radiation detector 10 according to this modification example has the same configuration as the radiation detector 10 (see FIG. 6) except that it does not comprise the second receiving unit 78.

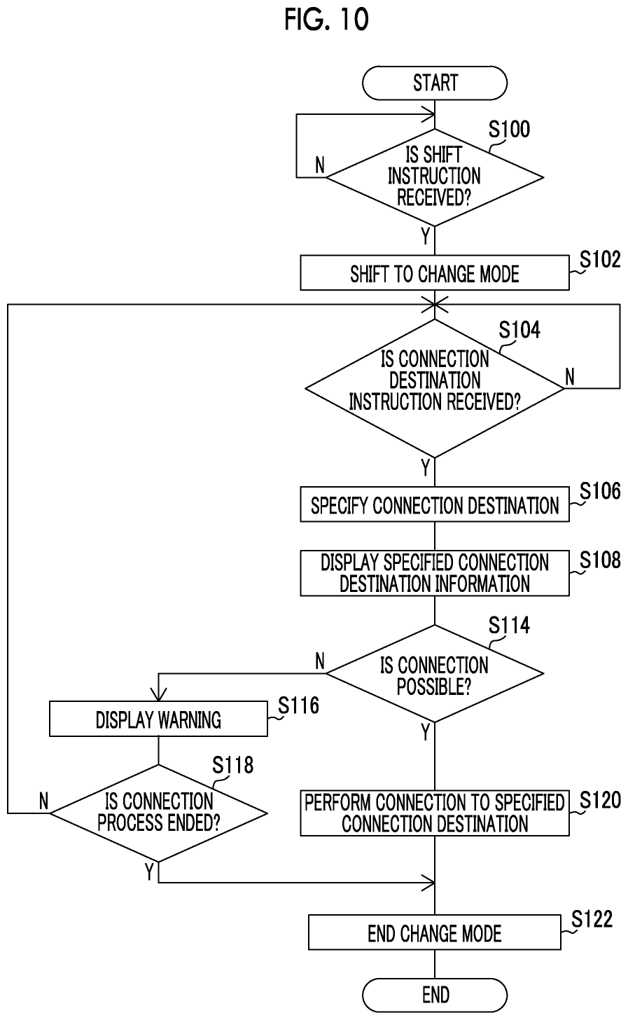

On the other hand, FIG. 10 is a flowchart illustrating an example of the flow of a connection process performed in the radiation detector 10 according to this modification example. As illustrated in FIG. 10, the connection process according to this modification example differs from the connection process according to the above-described embodiment (see FIG. 6) in that it does not comprise Steps S110 and S112.

As illustrated in FIG. 10, in this modification example, the determination result in Step S104 is “No” until the first receiving unit 70 receives the connection destination instruction. On the other hand, in a case in which the first receiving unit 70 receives the connection destination instruction, the determination result in Step S104 is “Yes”, and the process proceeds to Step S106. In addition, in this modification example, it is preferable that, in Step S106, the specification unit 72 specifies the connection destination finally selected by the repeated operation of the operation button 28₂ by the user. For example, in a case in which the operation button 28₂ is not operated again even after a predetermined period of time has elapsed since the operation button 28₂ was operated, the specification unit 72 specifies the connection destination selected by the final operation of the operation button 28₂.

Further, after Step S108, in Step S114, the determination unit 74 determines whether or not the connection to the connection destination specified in Step S106 by wireless communication is possible. In other words, the determination unit 74 determines whether or not the connection to the connection destination selected by the user by wireless communication is possible. In a case in which the determination unit 74 determines that the connection is possible, the process proceeds to Step S120, and the connection unit 80 is the connection destination specified in Step S106 by wireless communication in Step S120. In other words, the connection unit 80 connects the connection destination selected by the user and the radiation detector 10 using wireless communication.

As described above, according to this modification example, it is possible to connect the connection destination (the console 12 or the console 14) and the radiation detector 10, without requiring the user to decide the selection of the connection destination.

### Second Embodiment

In the first embodiment, in a case in which the first receiving unit 70 receives the decision instruction, in other words, in a case in which the user completes the selection of the desired connection destination, it is determined whether or not the connection to only the connection destination selected by the user by wireless communication is possible. In contrast, in this embodiment, an aspect will be described in which the connection destination to be subjected to the determination of whether connection is possible is different from that in the first embodiment.

In addition, since the configurations of a radiography system 1 and consoles 12 and 14 according to this embodiment are the same as those in the first embodiment, the description thereof will not be repeated.

On the other hand, since the operation of the radiation detector 10 according to this embodiment, specifically, the connection process performed by the radiation detector 10 differs from the connection process according to the first embodiment (see FIG. 6), the connection process according to this embodiment will be described.

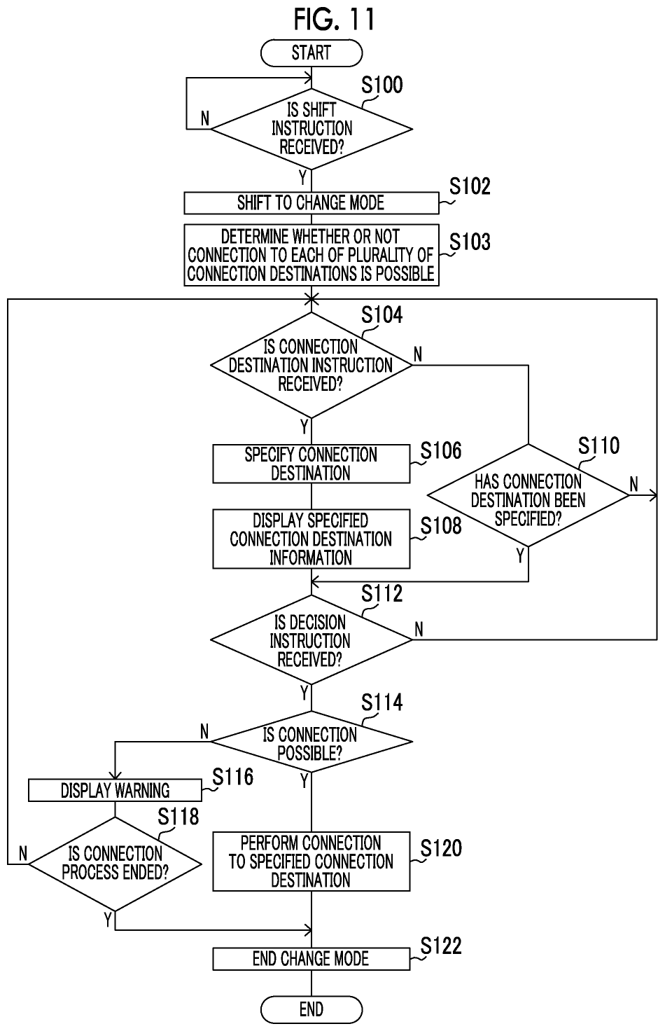

FIG. 11 is a flowchart illustrating an example of the flow of the connection process performed in the radiation detector 10 according to this embodiment. As illustrated in FIG. 11, the connection process according to this embodiment differs from the connection process (see FIG. 6) according to the first embodiment in that it comprises a process in Step S103 between Step S102 and Step S104.

As illustrated in FIG. 11, in Step S103, the determination unit 74 determines whether or not a connection to each of a plurality of connection destinations by wireless communication is possible. For example, the determination unit 74 according to this embodiment determines whether or not the connection to each of n connection destinations stored in the storage unit 32 as the connection destination information 33 by wireless communication is possible. The determination result of the determination unit 74 is temporarily stored in the storage unit 32.

As described above, in this embodiment, it is determined whether or not the connection to each of the plurality of connection destinations set as the connection destination information 33 by wireless communication is possible, regardless of whether or not the first receiving unit 70 receives the connection destination instruction.

In addition, in this embodiment, in a case in which the determination unit 74 determines in Step S114 whether or not the connection to the connection destination specified in Step S106 by wireless communication is possible, the determination unit 74 determines whether or not wireless communication is possible with reference to the determination result temporarily stored in the storage unit 32 by the process in Step S103.

The selection of the connection destination by the user is the same as that in the first embodiment. However, the determination unit 74 according to this embodiment determines in advance whether or not the connection to all of the connection destinations assumed as the connection destinations of the radiation detector 10 by wireless communication is possible, regardless of the selection of the connection destination by the user. In the example illustrated in FIG. 11, before the second receiving unit 78 receives the decision instruction, the determination unit 74 determines in advance whether or not the connection to all of the connection destinations assumed as the connection destinations of the radiation detector 10 by wireless communication is possible.

As described above, in this embodiment, it is determined in advance whether or not the connection is possible by wireless communication, regardless of the selection of the connection destination by the user. Therefore, in a case in which the user selects a connection destination, it is possible to promptly obtain the determination result.

### Modification Example 2

In this modification example, a modification example of the timing when the determination unit 74 determines whether or not the connection to all of the connection destinations assumed as the connection destinations of the radiation detector 10 by wireless communication is possible will be described.

In this modification example, the determination unit 74 performs a determination process of determining whether or not the connection to all of the connection destinations assumed as the connection destinations of the radiation detector 10 by wireless communication is possible at predetermined intervals separately from the connection process. For example, the determination process is repeated every time a predetermined period elapses while the radiation detector 10 is turned on and radiography is not performed.

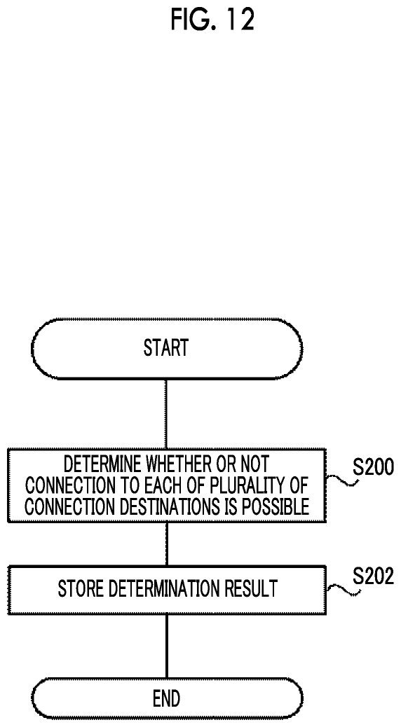

FIG. 12 is a flowchart illustrating an example of the determination process performed by the determination unit 74. In Step S200 of FIG. 12, the determination unit 74 determines whether or not a connection to each of a plurality of connection destinations by wireless communication is possible. Similarly to Step S103 of the connection process illustrated in FIG. 11, the determination unit 74 determines whether or not the connection to each of n connection destinations stored in the storage unit 32 as the connection destination information 33 by wireless communication is possible.

Then, in Step S202, after storing the determination result for each connection destination in the storage unit 32, the determination unit 74 ends the determination process.

In addition, in the case of this modification example, since the determination process is performed separately as described above, Step S103 (see FIG. 11) can be omitted in the connection process.

As described above, according to this modification example, it may not be determined whether or not the connection to the connection destination by wireless communication is possible in the connection process. Therefore, it is possible to further reduce the time required for the connection process.

In each of the above-described embodiments, the aspect has been described in which, even though the determination unit 74 determines that the connection to the connection destination by the wireless communication is not possible, the user can select the connection destination. However, the following aspects may be used: the user is prohibited from selecting the connection destination to which the connection is determined to be impossible; and the connection destination to which the connection is determined to be impossible is not displayed regardless of the operation of the operation button 28₂.

As described above, the radiation detector 10 according to each of the above-described embodiments can perform wireless communication and comprises the CPU 30A as at least one processor in the housing 20 accommodating the radiation detection unit 35. The CPU 30A receives the connection destination change instruction input by operating the operation button 28 provided in the housing 20 in order to input the instruction to change the connection destination of wireless communication. In addition, in a case in which the CPU 30A receives the change instruction, the CPU 30A specifies a connection destination corresponding to the change instruction from a plurality of preset connection destinations. Further, the CPU 30A determines whether or not the connection to the plurality of connection destinations by wireless communication is possible. Furthermore, in a case in which the CPU 30A determines that the connection to the specified connection destination by wireless communication is not possible, the CPU 30A performs control to display information indicating that the connection is not possible on the display unit 24 provided in the housing 20.

As described above, the radiation detector 10 according to each of the above-described embodiments performs control to specify a connection destination corresponding to the change instruction input by the operation of the operation buttons 28 provided in the housing 20 by the user from the plurality of connection destinations, to determine whether or not the connection by wireless communication is possible, and to display a warning indicating that the connection is not possible on the 7-segment display 27 in a case in which it is determined that the connection is not possible.

Therefore, the radiation detector 10 according to each of the above-described embodiments can be easily connected to a desired connection destination by wireless communication. Further, the user only needs to check the warning displayed on the 7-segment display 27 of the display unit 24 in the housing 20. Therefore, it is possible to easily check that the connection by wireless communication is not possible.

Furthermore, according to the radiation detector 10 of each of the above-described embodiments, the radiation detector 10 and a desired connection destination can be stably connected to each other by wireless communication. Therefore, even in a case in which there are a plurality of types of connection destinations, such as the consoles 12 and the consoles 14, the radiation detector 10 can be stably connected to a desired connection destination by wireless communication.

In addition, in each of the above-described embodiments, the console 12 or the console 14 is given as an example of the connection destination of the radiation detector 10. However, the connection destination is not limited to the console. For example, the connection destination may be a router or an access point in wireless communication, or a host in other types of communication. Further, the type and number of connection destinations that can be connected to the radiation detector 10 are not limited. In each of the above-described embodiments, two types of modes corresponding to the types of connection destinations, that is, the stationary type and the mobile type have been described. However, the modes are not limited thereto.

Further, in each of the above-described embodiments, the aspect in which the console 12 and the console 14 are connected to the radiation detector 10 by wireless communication through the same network N has been described. However, the console 12 and the console 14 may be connected to the radiation detector 10 by wireless communication through separate networks.

Furthermore, in each of the above-described embodiments, the display control unit 76 may further perform control to display information on the connection destination to which the connection by wireless communication is determined to be possible and the display unit 24 in the same display aspect. For example, an icon (not illustrated) indicating the radiation detector 10 that is displayed on a display unit (not illustrated) included in the connection destination to which the connection by wireless communication is determined to be possible and the 7-segment display 27 of the display unit 24 may emit light of the same color. As described above, in a case in which information is displayed on the radiation detector 10 and the connection destination in the same display aspect, it is possible to clearly recognize a combination of the radiation detector 10 and the connection destination connected to each other. For example, in a case in which a plurality of radiation detectors 10 are associated with one console, it may be difficult to determine which of the radiation detectors 10 the console is connected by wireless communication. In this case, the configuration in which information is displayed on the radiation detector 10 and the connection destination in the same display aspect makes it possible for the console 12 to easily recognize the combination of the radiation detector 10 and the console connected to each other. Further, in this case, the information displayed in the same display aspect is not particularly limited. The present disclosure is not limited to the aspect in which characters or marks are displayed. As described above, the above-mentioned predetermined icon or display unit may only be turned on. Further, the display aspect is not limited to the display of the same color. For example, a display aspect in which the same pattern is displayed on the radiation detector 10 and the connection destination may be used, or a display aspect in which the blinking timing of display is synchronized may be used.

Further, in each of the above-described embodiments, for example, the following various processors can be used as the hardware structure of processing units performing various processes such as the first receiving unit 70, the specification unit 72, the determination unit 74, the display control unit 76, the second receiving unit 78, and the connection unit 80. The various processors include, for example, a programmable logic device (PLD), such as a field programmable gate array (FPGA), that is a processor whose circuit configuration can be changed after manufacture and a dedicated electric circuit, such as an application specific integrated circuit (ASIC), that is a processor having a dedicated circuit configuration designed to perform a specific process, in addition to the CPU that is a general-purpose processor which executes software (programs) to function as various processing units as described above.

One processing unit may be configured by one of the various processors or a combination of two or more processors of the same type or different types (for example, a combination of a plurality of FPGAs or a combination of a CPU and an FPGA). Further, a plurality of processing units may be configured by one processor.

A first example of the configuration in which a plurality of processing units are configured by one processor is an aspect in which one processor is configured by a combination of one or more CPUs and software and functions as a plurality of processing units. A representative example of this aspect is a client computer or a server computer. A second example of the configuration is an aspect in which a processor that implements the functions of the entire system including a plurality of processing units using one integrated circuit (IC) chip is used. A representative example of this aspect is a system-on-chip (SoC). In this way, various processing units are configured by using one or more of the various processors as a hardware structure.

In addition, specifically, an electric circuit (circuitry) obtained by combining circuit elements, such as semiconductor elements, can be used as the hardware structure of the various processors.

In each of the above-described embodiments, the aspect in which the information processing program 31 is stored (installed) in the storage unit 32 in advance has been described. However, the present disclosure is not limited thereto. The information processing program 31 may be recorded on a recording medium, such as a compact disc read only memory (CD-ROM), a digital versatile disc read only memory (DVD-ROM), or a universal serial bus (USB) memory, and then provided. In addition, the information processing program 31 may be downloaded from an external device through a network.

What is claimed is:

1. An information processing device comprising:
at least one processor that is provided in a housing of a radiation detector which is capable of performing wireless communication,
wherein the processor receives an instruction to change a connection destination of the wireless communication which is input by operating an operation button that is provided in the housing to input the instruction to change the connection destination, specifies a connection destination corresponding to the change instruction from a plurality of preset connection destinations in a case in which the change instruction is received, determines whether or not a connection to the plurality of connection destinations by the wireless communication is possible, and performs control to display information indicating that the connection is not possible on a display unit provided in the housing in a case in which it is determined that the connection to the specified connection destination by the wireless communication is not possible.

2. The information processing device according to claim 1,
wherein the processor further receives a connection decision instruction input by operating a decision button that is provided in the housing to decide the connection to the connection destination corresponding to the change instruction and is connected to the specified connection destination by the wireless communication in a case in which the decision instruction is received and it is determined that the connection to the specified connection destination by the wireless communication is possible.

3. The information processing device according to claim 1,
wherein, in a case in which it is determined that the connection to the specified connection destination by the wireless communication is possible, the processor is connected to the specified connection destination by the wireless communication.

4. The information processing device according to claim 1,
wherein the change instruction includes a shift instruction to shift to a wireless communication connection destination change mode and a connection destination instruction indicating a connection destination which is a change destination selected from the plurality of connection destinations after the instruction to shift to the change mode, and
the processor specifies a connection destination corresponding to the connection destination instruction from the plurality of connection destinations.

5. The information processing device according to claim 4,
wherein the processor determines whether or not the connection to each of the plurality of connection destinations by the wireless communication is possible in a case in which the shift instruction is received, and determines whether or not the connection to the connection destination corresponding to the connection destination instruction by the wireless communication is possible on the basis of a result of determining whether or not the connection to each of the plurality of connection destinations by the wireless communication is possible in a case in which the connection destination instruction is received.

6. The information processing device according to claim 1,
wherein the processor repeatedly determines whether or not the connection to each of the plurality of connection destinations by the wireless communication is possible at a predetermined timing.

7. The information processing device according to claim 1,
wherein the processor determines whether or not the connection to the specified connection destination among the plurality of connection destinations by the wireless communication is possible.

8. The information processing device according to claim 1,
wherein there are a plurality of types of the connection destinations,
the display unit has a type display unit indicating the plurality of types, and
the processor further performs control to display information indicating the type of the specified connection destination on the type display unit.

9. The information processing device according to claim 1,
wherein the processor further performs control to display information on a connection destination to which the connection by the wireless communication is determined to be possible and the display unit in the same display aspect.

10. A radiation detector comprising:
a wireless communication unit;
a radiation detection unit that generates image data indicating a radiographic image corresponding to emitted radiation;
a housing that accommodates the radiation detection unit; and
the information processing device according to claim 1.

11. An information processing method comprising:
causing a processor, which is provided in a housing of a radiation detector that is capable of performing wireless communication, to perform a process including:
receiving an instruction to change a connection destination of the wireless communication which is input by operating an operation button that is provided in the housing to input the instruction to change the connection destination;
specifying a connection destination corresponding to the change instruction from a plurality of preset connection destinations in a case in which the change instruction is received;
determining whether or not a connection to the plurality of connection destinations by the wireless communication is possible; and
performing control to display information indicating that the connection is not possible on a display unit provided in the housing in a case in which it is determined that the connection to the specified connection destination by the wireless communication is not possible.

12. A non-transitory computer-readable storage medium storing an information processing program that causes a processor, which is provided in a housing of a radiation detector that is capable of performing wireless communication, to perform a process comprising:
receiving an instruction to change a connection destination of the wireless communication which is input by operating an operation button that is provided in the housing to input the instruction to change the connection destination;
specifying a connection destination corresponding to the change instruction from a plurality of preset connection destinations in a case in which the change instruction is received;
determines whether or not a connection to the plurality of connection destinations by the wireless communication is possible, and
performing control to display information indicating that the connection is not possible on a display unit provided in the housing in a case in which it is determined that the connection to the specified connection destination by the wireless communication is not possible.
